(19) United States
(12) Patent Application Publication
(10) Pub. No.: US 2017/0225681 A1
(43) Pub. Date: Aug. 10, 2017

(54) DRIVING SUPPORT APPARATUS, SERVER, AND NON-TRANSITORY COMPUTER-READABLE MEDIUM

(71) Applicant: ZENRIN CO., LTD., Kitakyushu-shi (JP)

(72) Inventors: Kenichiro MOTOYAMA, San Mateo, CA (US); Hiroyuki OHARA, Kitakyushu-shi (JP)

(73) Assignee: ZENRIN CO., LTD., Kitakyushu-shi (JP)

(21) Appl. No.: 15/427,979

(22) Filed: Feb. 8, 2017

(30) Foreign Application Priority Data
Feb. 10, 2016 (JP) 2016-023369

(51) Int. Cl. B60W 30/12

(52) U.S. Cl. CPC B60W 30/12; B60W 2420/42

(57) ABSTRACT

A driving support apparatus that includes processing circuitry that receives lane information and feature information of a feature situated on a road or around the road, the lane information including lane base line information of a base line arranged for each of a plurality of lanes of the road, the feature information including position information of the feature, the feature information being correlated with the lane base line information, identifies a traveling lane along which a vehicle is travelling among the plurality of lanes based on a present position of the vehicle and the lane base line information, and identifies the feature information associated with the identified traveling lane, and outputs information for supporting driving of the vehicle based on the feature information associated with the traveling lane.

### CROSS-REFERENCE TO RELATED APPLICATION

This application claims priority based on Japanese Patent Application No. 2016-023369, filed on Feb. 10, 2016, the entire contents of which are incorporated by reference herein.

### FIELD

The present disclosure relates to a driving support system.

### BACKGROUND

A system for estimating a position of an own vehicle with accuracy and supporting driving of the vehicle has recently been popularized. In connection to this, a technology is proposed which is configured to include an image pickup device mounted on the own vehicle and a feature information acquiring unit, to check an image obtained from the image pickup device and feature information obtained from the feature information acquiring unit, and to determine a lane in which the own vehicle is present among a plurality of lanes (JP-B-4886597).

### SUMMARY

According to an aspect of the present disclosure, there is provided a driving support apparatus comprising: processing circuitry configured to receive lane information and feature information of a feature situated on a road or around the road, the lane information including lane base line information of a base line arranged for each of a plurality of lanes of the road, the feature information including position information of the feature, the feature information being correlated with the lane base line information; identify a traveling lane along which a vehicle is travelling among the plurality of lanes based on a present position of the vehicle and the lane base line information; identify the feature information associated with the identified traveling lane; and output information for supporting driving of the vehicle based on the feature information associated with the traveling lane.

According to this driving support system, information about the feature having an effect on a travel mode in a traveling lane of an own vehicle out of the pre-stored feature disposition information is used for the driving support. Thereby, the driving support according to the traveling lane of the own vehicle can be realized while reducing an amount of access to map data.

In the driving support system of the aspect, the memory unit may further include and stores length information of a length which range covers the vehicle traveling environment corresponding to the feature in a direction of a lane base line. The vehicle management unit outputs at least one of a piece of support information for supporting speed control of the vehicle based on the length information or a piece of support information for supporting steering control of the vehicle based on the length information.

In the driving support system of the aspect, the vehicle management unit may further correct the present position of the vehicle detected by a position detector based on the feature information.

The foregoing characteristics do not enumerate all characteristics of the present disclosure, and a configuration (or a method) adopting these as key portions can also serve as a disclosure.

### BRIEF DESCRIPTION OF THE DRAWINGS

FIG. 1 is a diagram illustrating a configuration of a driving support system 10 as an embodiment of the disclosure:

FIG. 2 is a view illustrating a road environment around a vehicle, corresponding to lane information 431;

FIG. 3 is a flow chart illustrating driving support processing in a first embodiment;

FIG. 4 is a view illustrating a content of information for driving support in the first embodiment;

FIG. 5 is a view illustrating the road environment around the vehicle, corresponding to the lane information 431;

FIG. 6 is a flow chart illustrating driving support processing in a second embodiment;

FIG. 7 is a view illustrating an example of the road environment around the vehicle;

FIG. 8 is a view illustrating the road environment around the vehicle, corresponding to the lane information 431;

FIG. 9 is a flow chart illustrating driving support processing in a third embodiment; and

FIG. 10 is a view illustrating the road environment around the vehicle, corresponding to the lane information 431.

### DETAILED DESCRIPTION OF THE DISCLOSURE

### A. First Embodiment

### A1. System Configuration

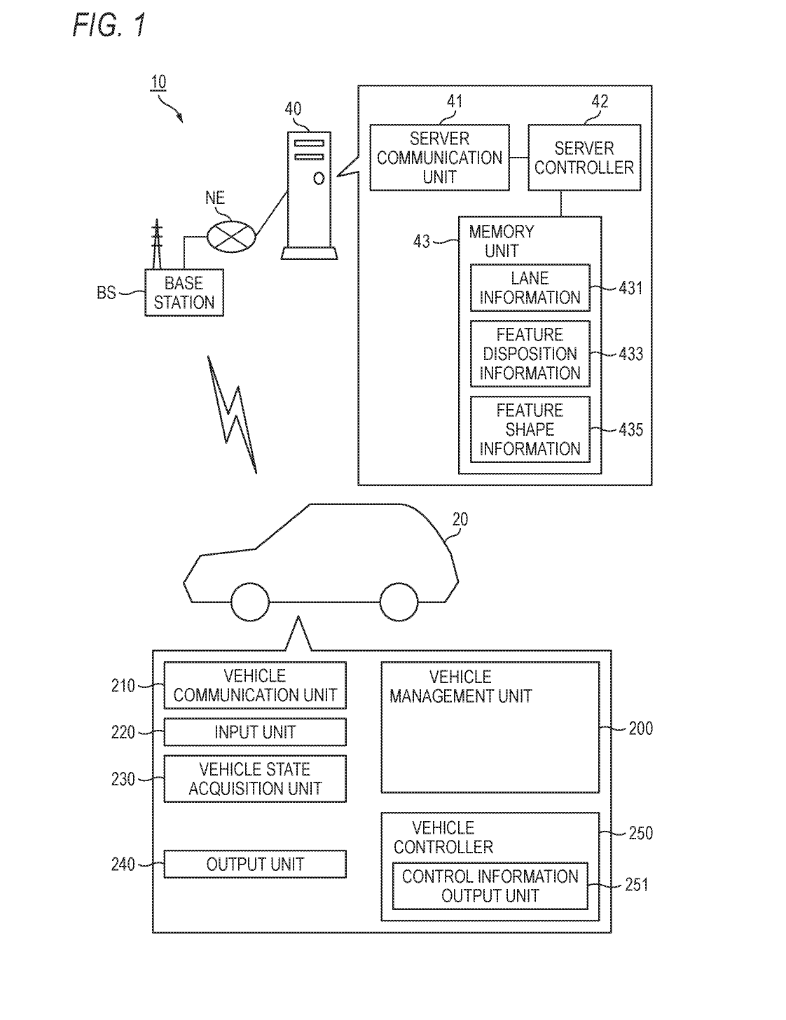

As illustrated in FIG. 1, a driving support system 10 serving as an embodiment of the present disclosure is a system for supporting driving of a vehicle 20, and is configured to include the vehicle 20 and a server 40. The vehicle 20 and the server 40 are connected to enable communication with each other via an Internet NE and a base station BS.

The vehicle 20 is provided with a vehicle management unit 200 including a processor, a vehicle communication unit 210, an input unit 220, a vehicle state acquisition unit 230, an output unit 240, and a vehicle controller 250. These components are connected to enable communication with each other by internal buses (not illustrated).

The vehicle management unit 200 is provided with a RAM and a ROM (which are not illustrated). The vehicle management unit 200 executes a control program stored in the ROM by developing the control program into the RAM, and thereby performs processes based on information supplied from the vehicle state acquisition unit 230, such as a process of creating information for setting control timing of an accelerator or a brake, and a process of outputting the information to the vehicle controller 250, besides a process of detecting a present position of the vehicle 20.

The vehicle communication unit 210 is a device that performs communication between the vehicle 20 and the server 40 via the Internet NE. The input unit 220 is a device that receives various inputs such as destination setting, via point setting by a user of the driving support system 10. The vehicle state acquisition unit 230 acquires information for detecting the present position of the vehicle 20 based on a radio wave received from an artificial satellite constituting a global positioning system (GPS) that is a satellite positioning system. Further, the vehicle state acquisition unit 230 may be provided with an autonomous navigation sensor (not illustrated), and supply information obtained by the autonomous navigation sensor to the vehicle management unit 200 along with radio wave information. The vehicle state acquisition unit 230 is provided with an image pickup camera (not illustrated) that is a device that recognizes an environment of a road along which the vehicle will travel, and uses a charge coupled device (CCD) camera as the image pickup camera in the present embodiment. The output unit 240 is a device that outputs and displays various images such as a map image. The vehicle controller 250 is a device that uses various pieces of control information for engine control or the like via a control information output unit 251 based on information supplied from the vehicle management unit 200.

The server 40 is provided with a server communication unit 41, a server controller 42, and a memory unit 43. The server communication unit 41 is a device that performs communication between the vehicle 20 and the server 40 via the Internet NE under the control of the server controller 42. The server controller 42 is provided with a RAM and a ROM which are not illustrated, and executes a control program stored in the ROM by developing the control program into the RAM, thereby controlling each unit of the server 40.

Lane information 431, feature disposition information 433, and feature shape information 435 are stored in the memory unit 43. Information (hereinafter referred to as “lane base line information”) associated with a lane base line represented in a line shape per lane along which the vehicle can travel is included in the lane information 431. Information corresponding to the lane base line representing a specific lane, i.e. information about a predetermined feature having an effect on a travel mode of a vehicle that travels along a specific lane among lanes stored as the lane base line information, is included in the feature disposition information 433. Information correlating a given coordinate point of a sequence of coordinate points constituting the lane base line information with a coordinate point included in the feature shape information 435 is included in the feature disposition information 433. Further, a unique ID of the lane base line information and a unique ID of the feature stored as the feature shape information 435 may be configured to be included in the feature disposition information 433. Position information about an existence position of the feature, and information about a shape of each of, for instance, a feature set forth in a linear shape made up of a sequence of coordinate points, a feature set forth in a polygonal shape made up of at least one of sequences of coordinate points, and a feature set forth in a planar shape by giving a height to a segment made up of a sequence of given points are included in the feature shape information 435. In the present embodiment, the memory unit 43 is made of a hard disk.

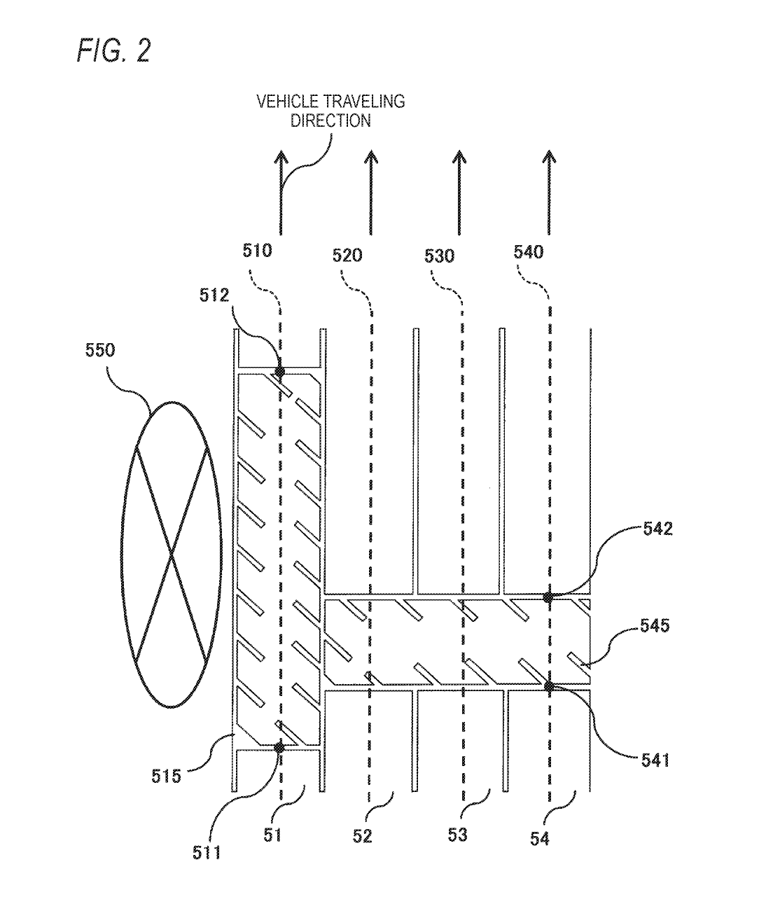

Next, the lane information 431 will be described. Note that the illustration of FIG. 2 well describes the situation in which the vehicle 20 runs through the left-hand lanes. As illustrated in FIG. 2, in a one-side 4-lane road where a police station 550 is present on the left of a roadway, road markings 515 and 545 representing stop prohibition are painted on respective lanes. How much range a stop prohibition portion covers is presented to movers by the road markings 515 and 545. Compared by length in a vehicle traveling direction, the road marking 515 of the leftmost lane is relatively longer than the road marking 545 painted on the other three lanes side by side. As illustrated in FIG. 2, in the road to which the road markings indicating such stop prohibition are given, once a vehicle enters a portion to which the road marking of the stop prohibition is given, the vehicle cannot be stopped within a zone of the road marking. Here, when only one lane has a longer road surface zone portion representing the stop prohibition compared to the other lanes as in FIG. 2, vehicle control is not made identical on all the lanes, but vehicle control corresponding to the road marking is preferably performed in units of individual lanes.

The information stored in the memory unit 43 of the present system includes information about the lanes and information about the range of the road marking representing the stop prohibition of each of the lanes. To be specific, lane base line information 510, 520, 530, and 540 indicating respectively the lanes 51, 52, 53, and 54 in the shape of an approximate center line are stored as the lane information 431 in the memory unit 43. Moreover, the feature disposition information 433, namely data in which a specific feature having an effect on a travel mode of a vehicle when the vehicle runs on a specific lane is associated with specific lane base line information is stored in the memory unit 43. To put it simply, on the one hand there is the feature disposition information 433, in which a predetermined coordinate point in the lane base line information is included, and the other hand there is a predetermined coordinate point included in the feature shape information 435, embracing information indicating an existence position and a shape of each of the features having an effect on movement of a vehicle in each lane, and on that basis, at least one predetermined coordinate point of said information 433 is correlated with one coordinate point included in said information 435 and is stored in the memory unit 43. In this sense, said stored content helps the vehicle management unit 200 to identify whether a specific feature is relevant at any position of a specific lane base line.

To be specific, the lane base line information 510 indicating the leftmost lane in a line shape in FIG. 2, and information about the position of the road marking 515 representing the stop prohibition (on a vehicle traveling in the lane 51 corresponding to the lane base line information 510) as the feature shape information 435 are stored in the memory unit 43. Further, according to the stored content of the feature disposition information 433 of the memory unit 43, the lane base line information 510 is stored with a corresponding relationship to information about predetermined coordinate points for showing the shape of the road marking 515 and/or about a position of the point on the line connecting these predetermined coordinate points. Here, the aforementioned entry-side point 511 is a point corresponding to a start of a road portion where the aforementioned stop control of the vehicle is prohibited in the lane 51. Thus, coordinates of the entry-side point 511 are referred to as a specific control starting point SP. Coordinates of an exit-side point 512 are a point corresponding to an end of the portion where the aforementioned stop control of the vehicle is prohibited. Thus, the coordinates of the exit-side point 512 are referred to as a specific control endpoint EP. In the present embodiment, with regard to the road marking 515 that is a feature having an effect on the vehicle motion on the lane 51, the feature disposition information 433 is stored in the memory unit 43 of the driving support system 10 in such a manner that both the specific control starting point SP and the specific control endpoint EP are correlated with the two coordinate points constituting the lane base line information 510. In this way, data of the feature disposition information 433 in which the lane base line information 510 and the road marking 515 are correlated with the specific control starting point SP and the specific control endpoint EP is held in the memory unit 43. Thereby, when a vehicle travels on the lane 51, the driving support system 10 enables information indicating not to perform stop control when the vehicle enters the specific control starting point SP until the vehicle exits from the specific endpoint EP at the road portion connected from the specific control starting point SP to the specific control endpoint EP to be provided to the vehicle side in order that the information can be used for driving support.

In the way described above, the driving support system 10 in the present embodiment can provide information about prohibition of the vehicle stop control on one specific portion of a lane corresponding to the case in which the ranges of the road markings (the lengths in the vehicle traveling direction) representing the stop prohibition are different in units of individual lanes as illustrated in FIG. 2. To be specific, information of the road marking 515 showing a range of the stop prohibition on the lane 51 which is longer than ranges of the stop prohibition on the lanes 52 to 54 can be provided for a vehicle 20 as information about the passage of the vehicle on the lane 51. Here, since information of the road marking 545 on the lanes 52 to 54 having no relation with the passage on the lane 51 need not be used at the vehicle running through the lane 51, resources of the vehicle side can be effectively applied. Further, upon processing information about a specific lane along which a vehicle is to travel, only by referring the feature disposition information 433 corresponding to such a specific lane, a range in which specific control is required, namely a range from the specific control starting point SP to the specific control endpoint EP, can be specified. For this reason, a complicate process of referring the stored content of the individual feature shape information 435 and performing calculation every time an estimation of the range of the specific control is needed can be omitted. Therefore, driving support processing using information for such driving support will be described in the next paragraph.

### A2. Driving Support Processing

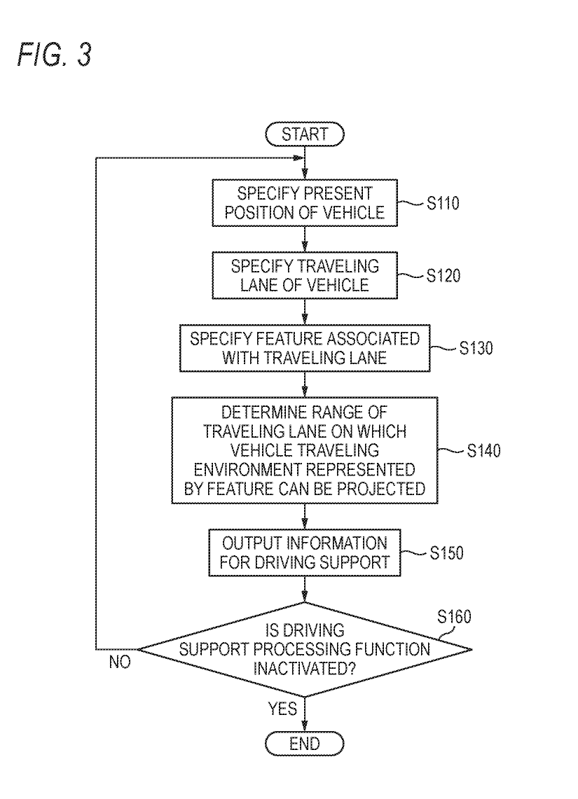

FIG. 3 is a flow chart for illustrating driving support processing in the first embodiment. In the present embodiment, as a driving support processing function of the driving support system 10 is activated, driving support processing is initiated.

When the driving support processing is initiated, the vehicle management unit 200 specifies a present position of the vehicle 20 depending on information supplied from the vehicle state acquisition unit 230 (step S110). To be specific, the vehicle management unit 200 detects the present position of the vehicle 20 using a radio wave which the vehicle state acquisition unit 230 receives from the artificial satellite constituting the GPS. Next, the vehicle management unit 200 refers the lane information 431 of the memory unit 43 based on the present position detected as described above. As described above, the lane base line information indicating each lane in a linear shape is included in the lane information 431 and is stored in the memory unit 43. Here, the lane base line information is to indicate a shape of each lane in an approximate center line, and is set forth by a set of coordinate points prepared at predetermined intervals, namely a sequence of coordinate points. The coordinate points constituting this lane base line information are compared with coordinates of the detected present position, and the lane base line information including specific coordinate points taking values closest to the coordinates of the detected present position is specified by the vehicle management unit 200 as information corresponding to the lane along which the vehicle 20 travels (step S120).

Next, the vehicle management unit 200 refers the feature disposition information 433 of the memory unit 43, and thereby specifies a feature that is correlated with a lane along which the vehicle 20 travels and has an effect on vehicle movement on the lane (step S130). To be specific, the feature indicated as the stored content in the feature shape information 435 that includes one specific coordinate point is specified as a feature having an effect on traffic on the lane along which the vehicle travels, on the grounds that the specific coordinate is also the constituent of the lane base line information indicating the lane along which the vehicle 20 travels, and accordingly, the said feature shape information 435 and the lane base line are associated with each other in the feature disposition information 433.

When a feature that is correlated with the lane along which the vehicle 20 travels and represents a road environment having an effect on vehicle movement on the lane is specified, the vehicle management unit 200 specifies a range in which information for supporting driving according to this feature is required (step S140).

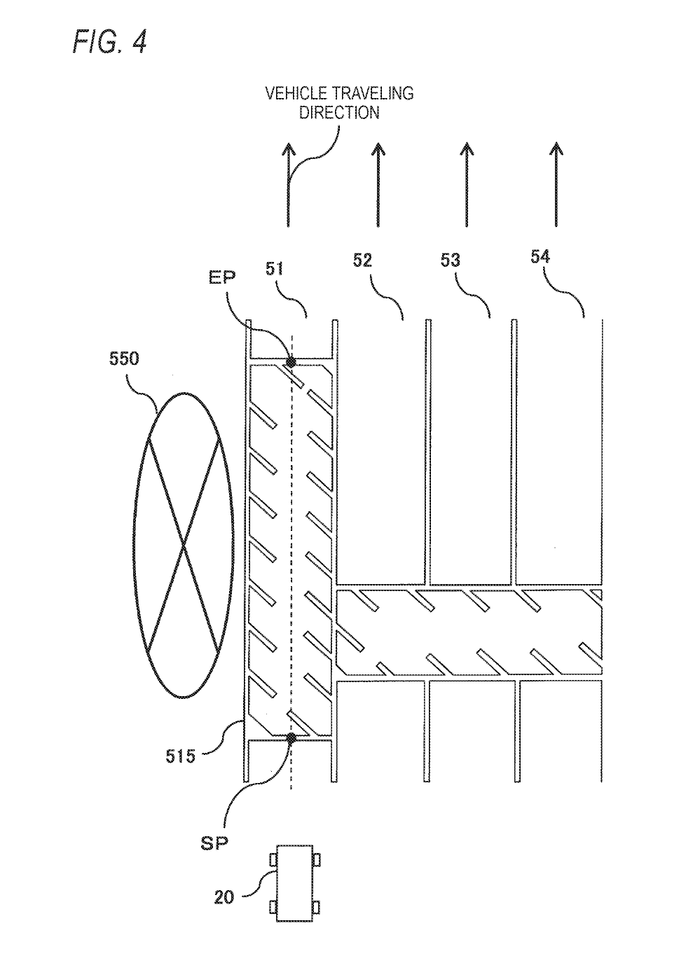

FIG. 4 is a view illustrating what information the vehicle management unit 200 of the driving support system 10 in the present embodiment supplies to the vehicle controller 250 by way of example. In FIG. 4, it is assumed that the vehicle 20 presently travels along the leftmost lane 51 without the intention of changing the lane and is located at a front side position (a near side position) of the road marking 515 representing the stop prohibition. In this case, information which a driver of the vehicle uses to operate the vehicle according to traffic regulation showing the stop prohibition on the lane is presented by the road marking 515 on the leftmost lane. That is, only the road marking 515 on the leftmost lane along which an own vehicle travels presents information useful to the vehicle 20, and the road marking 545 common to the other right lanes is irrelevant to a travel mode of the vehicle 20. For this reason, the vehicle management unit 200 refers the feature disposition information 433 correlated with the lane 51 along which the vehicle 20 is in the act of passing from the memory unit 43, reads the specific control starting point SP and the specific control endpoint EP in the lane base line, supplies position information of a starting point and an endpoint of a section within which the stop control of the vehicle is prohibited to the vehicle controller 250 (step S150), and thereby performs driving support. The control which the vehicle controller 250 performs according to the information supplied from the vehicle management unit 200 may be as follows.

For example, when it is detected from information which the image pickup camera constituting the vehicle state acquisition unit 230 obtains in advance that there are no other potentially collision causing vehicles within a predetermined distance in front of the vehicle 20, even if a brake operation is carried out by a driver until the vehicle enters the specific control starting point SP on the road marking 515 of FIG. 4 and then passes through the specific control endpoint EP on the road marking 515, the vehicle controller 250 prohibits or suppresses braking control. Thereby, the vehicle 20 is prevented from making a stop within the zone of the road marking 515. In this way, the vehicle management unit 200 may supply information for prohibiting or suppressing the braking control to the vehicle controller 250, and supply the vehicle controller 250 with information for instructing the driver of the vehicle 20 that the braking control is prohibited or suppressed such that the vehicle is not stopped once it enters the specific control starting point SP until it exits from the specific control endpoint EP in response to the road marking 515. When it is detected from the obtained information of the image pickup camera that there are other vehicles within the predetermined distance in front of the vehicle 20, a distance between the vehicle 20 and the front vehicle is insufficient, and a rear-end collision prevention mechanism provided for the vehicle 20 is automatically operated. Thus, the vehicle 20 may not avoid making a stop within an existence section of the road marking 515. In this case, to prevent an accidental stop resulting from the distance from the front vehicle, there is a need for vehicle control that the vehicle 20 reliably makes a stop for a moment at a front side position (a near side position) of the stop prohibition portion indicated by the road marking 515. Therefore, when the distance between the vehicle in front of the vehicle 20 and the vehicle 20 is not sufficient, the vehicle management unit 200 supplies the vehicle controller 250 with information for performing the braking control that makes a stop at a front point (a near point) of the specific control starting point SP. The vehicle management unit 200 supplies the vehicle controller 250 with information for suppressing acceleration of the vehicle 20 until the distance from the vehicle in front of the vehicle 20 is sufficiently secured at any moment while the vehicle 20 enters the specific control point SP and exits the specific control endpoint EP. Due to the vehicle control performed in this way, even in a road environment in which, in a plurality of one-side lanes, the range of the stop prohibition portion along each lane is not identical, the driving support of the vehicle according to the feature correlated with the lane along which the vehicle is in the act of passing can be performed.

The driving support processing of the driving support system 10 is terminated by inactivation of the driving support processing function. On the other hand, when the driving support processing function is not inactivated (NO in step S160), the flow returns to step S110, and thereby the driving support processing according to the driving support system 10 is continued.

In the aforementioned example, the specific control starting point SP and the specific control endpoint EP in the feature disposition information 433 are stored in the memory unit 43 as having the unique coordinates, respectively. However, with respect to the specific control endpoint EP stored as being included in the feature disposition information 433, a position may be specified by relative coordinates starting with values of the coordinates of the specific control starting point SP.

### B. Second Embodiment

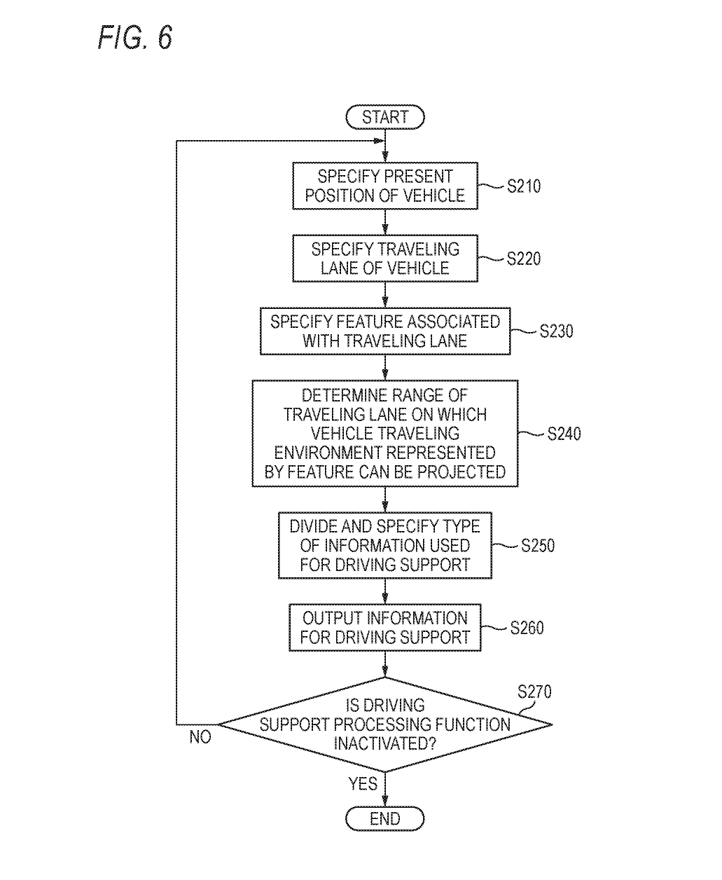

A configuration of a driving support system 10 in a second embodiment is identical to that of the first embodiment. In comparison with the driving support processing of the first embodiment, driving support processing of the second embodiment is different in processes (processes subsequent to step S250 in FIG. 6) latter than a process of fixing a range in which a traveling environment represented by a feature having an effect on a traffic mode on a lane amounts to a lane along which a vehicle travels, and is identical in the rest of the processes. That is, in the second embodiment, in place of the process of step S150 (of outputting the information for the driving support) in the first embodiment, the processes of steps S250 and S260 are performed.

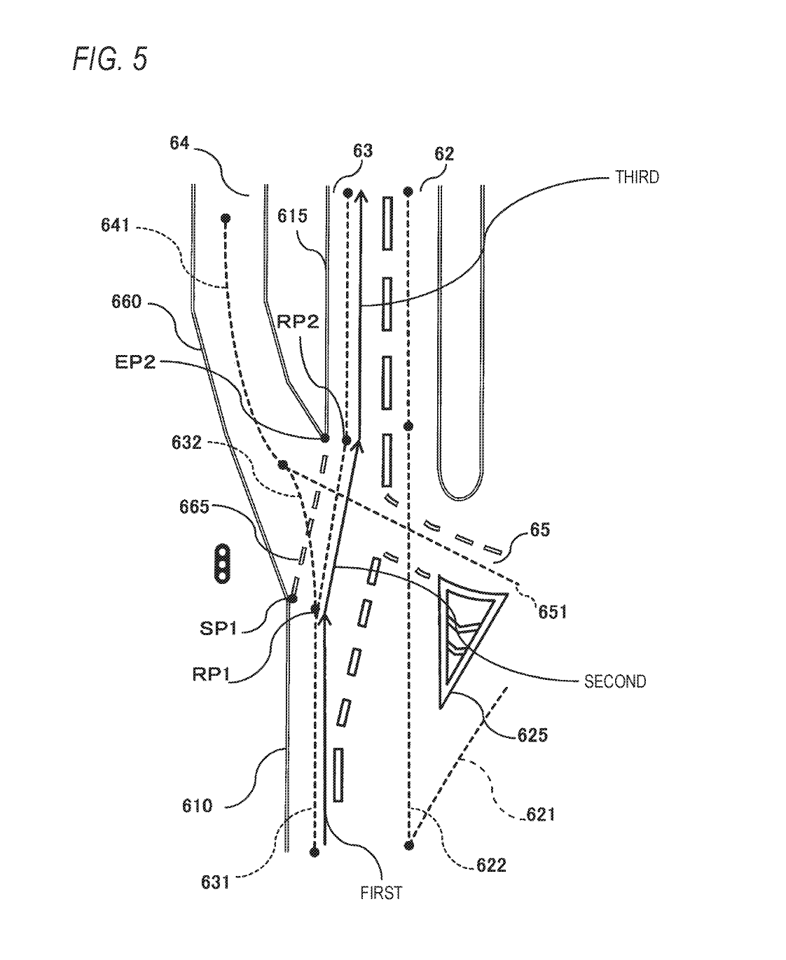

FIG. 5 is a view illustrating lane information 431 used in the driving support system 10 of the second embodiment. In FIG. 5, a one half side of a road that is a one-side 2-lane road having a structure in which a route fork of a route allowing of entry into an expressway deriving from a left lane 63 and a route continuing straight-traveling of the one-side 2-lane road takes place is illustrated. In the road portion illustrated in FIG. 5, a right lane 62 has also a road structure in which a route fork of a route turning right to an ordinary road (not illustrated) and a route continuing straight traveling takes place. The lane information 431 is stored in the memory unit 43 as indicating information of each lane. To be specific, the lane information 431 includes lane base line information as information represented by an approximate center line of each of lanes 62, 63, 64, and 65, and is stored in the memory unit 43. The lane 65 is such a lane that one of opposite lanes of the lanes 62 and 63 extends to lead to an expressway ramp 660 toward an expressway entrance (not illustrated). The lane 65 has relation to the lanes 62 and 63 to intersect each of the lanes 62 and 63, and has relation to the lane 64 to be connected and merged to the lane 64 at the expressway ramp 660. The feature disposition information 433 is stored in the memory unit 43, associating a feature set forth in the feature shape information 435—the feature having an effect on travelling of a vehicle running through either lane 62 or lane 63—with each of lane base lines 622 and 631 representing the lanes 62 and 63. To be specific, information of the lane base line 622 included in lane information of the lane 62 is correlated with position information included in one of data of the feature shape information 435 representing a buffer zone 625 illustrated in a zebra shape in FIG. 5 via one data of the feature disposition information 433. Likewise, information of the lane base line 631 of the lane 63 is correlated with position information of a lane line 665 illustrated in a dotted line shape in FIG. 5. The information of the lane base line 631 is information representing the approximate center line of the lane 63 in a linear shape. The information of the lane base line 631 is stored as being forked at a point in front of the expressway ramp 660 with respect to the information of the lane base line 632 corresponding to a linear shape representing a route that enters the expressway ramp 660 and is merged to the lane 64. Provided that this will be described from the side of the stored content of the memory unit 43 with respect to the information of the lane base line 632, the information of the lane base line 632 is set as a liner shape independently forked from the lane 63 stored as the information of the lane base line 631 in front of the lane line 665 indicating a boundary between the expressway ramp 660 and the lane 63 of the ordinary road, and is set as a linear shape merged to information of a lane base line 641 at a predetermined point at a predetermined portion of a region of the expressway ramp 660.

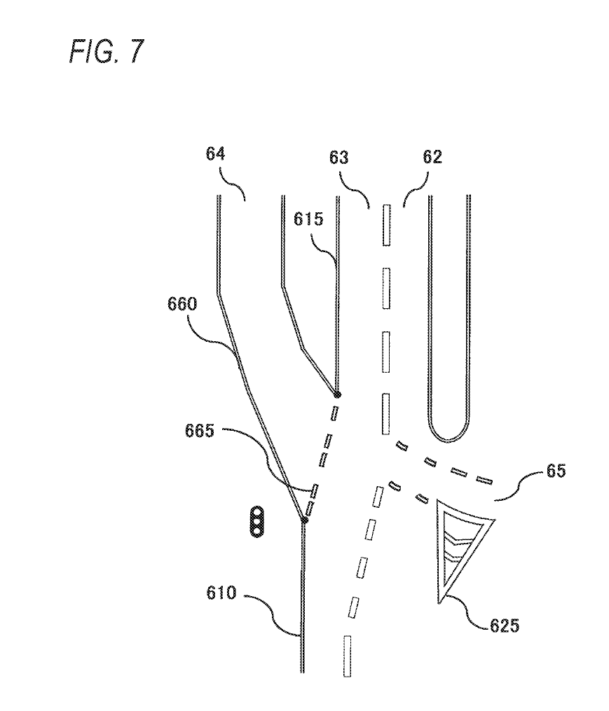

FIG. 6 is a flow chart illustrating driving support processing in the second embodiment. Processes of steps S210 to S230 are identical to the respective processes of steps S110 to S130 in FIG. 3, and thus description thereof will be omitted. When there is a feature correlated with a lane along which the vehicle 20 travels (such a feature is specified in step S230), the vehicle management unit 200 reads the feature disposition information 433 corresponding to lane base line information representing a traveling lane in an approximate center line, and fixes a range (a range in a vehicle traveling direction) of the feature having an effect on a vehicle travel mode of the traveling lane from the stored content of such feature disposition information 433 (step S240). In a traveling environment illustrated in FIGS. 5 and 7, a case in which the vehicle 20 travels along the lane 63 will be described by way of example. Unlike the traveling environment illustrated in FIG. 2 in the first embodiment, in the traveling environment illustrated in FIGS. 5 and 7, every single point constituting the lane line 665, which is a feature having an effect on a travel mode in the case of the vehicle 20 traveling along the lane 63, does not overlap any part of point sequences constituting the information of the lane base line 631 representing the lane 63 in the approximate center line. In such a case, the feature shape information describing the lane line 665 and the information of the lane base line 631 representing the lane 63 are correlated and stored in the memory unit 43 as the following stored contents in the feature disposition information 443. A related point RP1 that is one of the point sequences constituting the information of the lane base line 631 is a starting point of a second segment (to be described below) and is stored in the feature shape information 435 as a point intersecting a first segment. That being said, as the content of the feature disposition information 443, the related point RP1 is stored as a point corresponding to a foremost coordinate point SP1 when viewed in the vehicle traveling direction of the lane line 665 (here, a position of the coordinate point SP1 included in the lane line 665 may be set as a position of a starting point of a broken line on a real road surface, or it may be a position of a starting point at which a branch angle is generated between the roads to be forked as illustrated in FIG. 5). As a reference for setting the related point RP1 corresponding to SP1 in a feature situated at a position that does not directly intersect the lane base line like the lane line 665 by selecting only one from among the point sequences constituting the information of the lane base line 631, the following is suitable. That is, a specified point constituting the lane base line information is qualified as the related point in the lane base line information, because the said specified point is closest to an actual intersection point of the lane base line having relevance with a feature and a perpendicular line drawn from a point that is a point situated at a foremost position in the vehicle traveling direction among points included in information indicating an existence position and a shape of the feature and stored in the feature shape information 435. Using the same reference as this, a related point RP2 included in the point sequences constituting the information of the lane base line 631 is stored as the content of the feature disposition information 443 to correspond to a rearmost coordinate point EP2 in the lane line 665 when viewed in the vehicle traveling direction.

That is, when the lane line 665 is specified as the feature associated with the traveling lane (the lane 63), the vehicle management unit 200 reads out the feature disposition information 443 in which a correspondence relationship between the relevant lane line 665 and the lane 63 is described, and based on the fact that the related points RP1 and RP2 are included in such feature disposition information 443 in the way as described above, the vehicle management unit 200 designates the lane line 665 as representative of the traveling environment, having an effect on the traveling of the vehicle 20 in a range from RP1 to RP2 on the lane base line information corresponding to the lane 63 (step S240).

Afterwards, the vehicle management unit 200 performs a process of specifying a range in which, when a plurality of types of information used for the driving support are required, the feature having an effect on the vehicle travel mode and the traveling lane are correlated with each of such types of information in the lane base line information, from the stored content of the feature disposition information 433 based on a relationship between the feature having an effect on the vehicle travel mode of the traveling lane and the lane base line information in which the traveling lane is represented in a linear shape (step S250). Here, processed details of the vehicle management unit 200 in such step S250 will be described based on FIGS. 5 and 7.

FIG. 7 is a view illustrating only the lanes and the features in the road region illustrated in FIG. 5. In a road region illustrated in FIG. 7, when the vehicle 20 attempts to run the lane 63 along the road, edge lines 610 and 615 and a lane line 665 are present as features corresponding to a lane during vehicle traveling, and all these are at the left side of a vehicle. Since a traffic light illustrated in FIG. 7 is a signaling device for regulating passage of the lane 65 entering an expressway ramp and is a feature having no relation to the lane 63, the feature shape information 435 in which position information of such a traffic light is included is not stored in the memory unit 43 as information corresponding to the lane 63 (information of such a traffic light is not included in the feature disposition information 433 in which the feature and the lane base line information 631 in which the lane 63 is represented in the linear shape are correlated). As a result, complicated processing of the driving support system is avoided. This is because, in the said scene in which the vehicle 20 advances to the lane 63 along the road, the information about the traffic light is not treated as the information corresponding to the lane 63 by the vehicle management unit 200.

Here, since the lane line 665 among the features is a boundary separating the lane 63 and the expressway ramp portion, the vehicle 20 that goes straight down the lane 63 proceeds without crossing the relevant lane line 665. Meanwhile, when the vehicle is made to pass the lane 63 so as not to cross the lane line 665, a steering operation is at least required in a rightward direction as much as needed to avoid an existence range of the lane line 665. This is because, in the road structure illustrated in FIG. 7, the expressway ramp portion 660 is provided in a form in which it is inserted into the lane 63 from a left side to a right side. The foregoing will be described in detail in the next paragraph based on the description of FIGS. 5 and 7 from the viewpoint of the relation with the linear shape in the road structure.

As can be seen from the portion at which the lane base line information 631 for storing the lane 63 in the linear shape is illustrated in FIG. 5, the approximate center line of the lane 63 is identified by a combination of a segment (hereinafter, “first segment”) that extends in front of the expressway ramp portion 660 in a vertical direction in FIG. 5, a segment (hereinafter, “second segment”) that has a rightward inclination with respect to the vertical direction, and a segment (hereinafter, “third segment”) that extends in the vertical direction at a point past the expressway ramp portion 660 in the vehicle traveling direction. In FIG. 5, the first to third segments are put down at the right side of the lane base line 631 indicated by the broken line. Of course, the combination of the first to third segments representing the lane 63 is an exemplary type of a travel track of the vehicle traveling along the lane 63. The vehicle that should travel by following the approximate center line (formed from the combination of the first to third segments) stored in the memory unit 43 as the lane base line information 631 corresponding to this lane 63 requires steering corresponding to the rightward inclination which the second segment has.

In other words, in the case of the vehicle that should travel along a linear shape of the second segment included in the lane base line information 631, to perform traveling that draws a travel track deviating from the shape of the second segment to cross the lane line 665 means that the vehicle is aberrant from the travel track of the exemplary type. Accordingly, to avoid such a travel mode, it can be said that the steering operation that does not cross the lane line 665 in the vehicle operation is required. A parameter required for control (steering control) of such a steering operation is determined by a correlation with an entry speed of the vehicle to the portion of the second segment. Then, when the vehicle management unit 200 supplies the vehicle controller 250 with information about an individual travel mode of a vehicle that performs traveling following the linear shape stored as the lane base line information 631 for representing the portion of the second segment, there may be a need to provide a parameter applied to speed control of the vehicle (for instance, a parameter for reducing a speed from a high speed to a low speed) in combination with the parameter applied to the steering operation control.

In the traveling environment illustrated in FIGS. 5 and 7, when eliciting necessary information for the driving support, the vehicle management unit 200 of the vehicle 20 traveling along the lane 63 from the front in the backward direction specifies each of two types of information, which are called respectively control information for turning the vehicle in a rightward direction and control information for braking facilitating such rightward turning, at the position on the lane base line corresponding to the existence position of the lane line 665, namely in the aforementioned range from the related point RP1 to the related point RP2 (step S250). That is, parameter information for turning the vehicle 20 to the right side in the range from the related point RP1 to the related point RP2 is specified as one of information for the driving support, and parameter information applied to the braking of the vehicle 20 in the range from the related point RP1 to the related point RP2 is now specified as one type of information for the driving support. Thus, at the time of the traveling along the lane of the straight-traveling vehicle as illustrated in FIGS. 5 and 7, even when the steering control and the braking control are simultaneously required due to disposition of the lane line at the left side of the lane, the vehicle management unit 200 can divide driving support information applied to the different controls called the steering control and the braking control according to a type of control, and specify a range in which the parameter for performing each control is required.

The vehicle management unit 200 supplies the vehicle controller 250 with a plurality of types of information for the driving support at the portion of the lane base line that is range-specified by step S250 described above (step S260).

In the way described above, for a vehicle controlling unit to function properly, even when there are a plurality of types of information for the driving support corresponding to the traveling environment represented by the feature associated with the specific lane, the vehicle driving support system 10 of the present embodiment can help adequate traveling depending on the traveling environment using the information for the driving support in a necessary range as many as needed. Of course, in the present embodiment, with respect to the related point RP2 stored as being included in the feature disposition information 433, a position may also be specified by relative coordinates starting with the values of the coordinates of the related point RP1.

### C. Third Embodiment

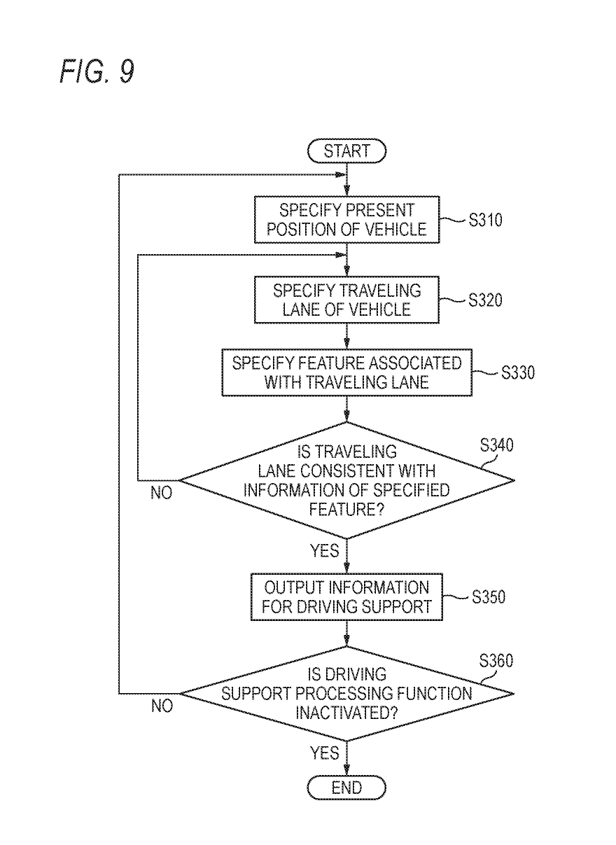

A configuration of a driving support system 10 in a third embodiment is identical to that of the first or second embodiment. In comparison with the driving support processing of the first embodiment, driving support processing of the third embodiment is different in the following points. The first different point is that, in a process (step S320 of FIG. 9) of specifying a traveling lane of a vehicle, with regard to information representing a lane used when the vehicle management unit 200 specifies the traveling lane of the vehicle 20, the vehicle draws a travel track like an extension line of the lane until then at a road portion (for instance, an intersection region) at which lanes are not clearly divided in a road structure, and a linear shape that becomes a standard of the travel track is treated as the same information as lane base line information. A stored content of a memory unit 43 which regulates a processing content of the vehicle management unit 200 in step S320 in the present embodiment will be described in detail. With regard to a road portion (for instance, an inside of an intersection) other than a road region in which the lanes are actually partitioned by a lane paint or the like, considering possibility of passage from a front lane (stored in the memory unit 43 as a lane base line) (other than an intersection) in a vehicle traveling direction to another rear lane (stored in the memory unit 43 as another lane base line) (other than the intersection) in the vehicle traveling direction, where there is connection between the lanes, information of a linear shape making up for different lanes is stored in the memory unit 43 as lane information. The present embodiment is characterized in that the linear shape (hereinafter referred to as “lane base line associated line”) making up for the different lanes in this way is stored in the memory unit 43 as representing the traveling lane as well.

The second different point is that, when there is a discrepancy by contrasting information of a feature read out as being associated with the traveling lane in step S330 that precedes step S340 and information which a vehicle state acquisition unit 230 acquires in conjunction with an actual road situation, a process of discarding information representing the traveling lane falsely specified in step S320 above as unreliable and seeking alternative information representing the actual traveling lane of the vehicle 20 is performed (when determined to be NO in step S340, the process returns to step S320 and is performed again). This process will be described below.

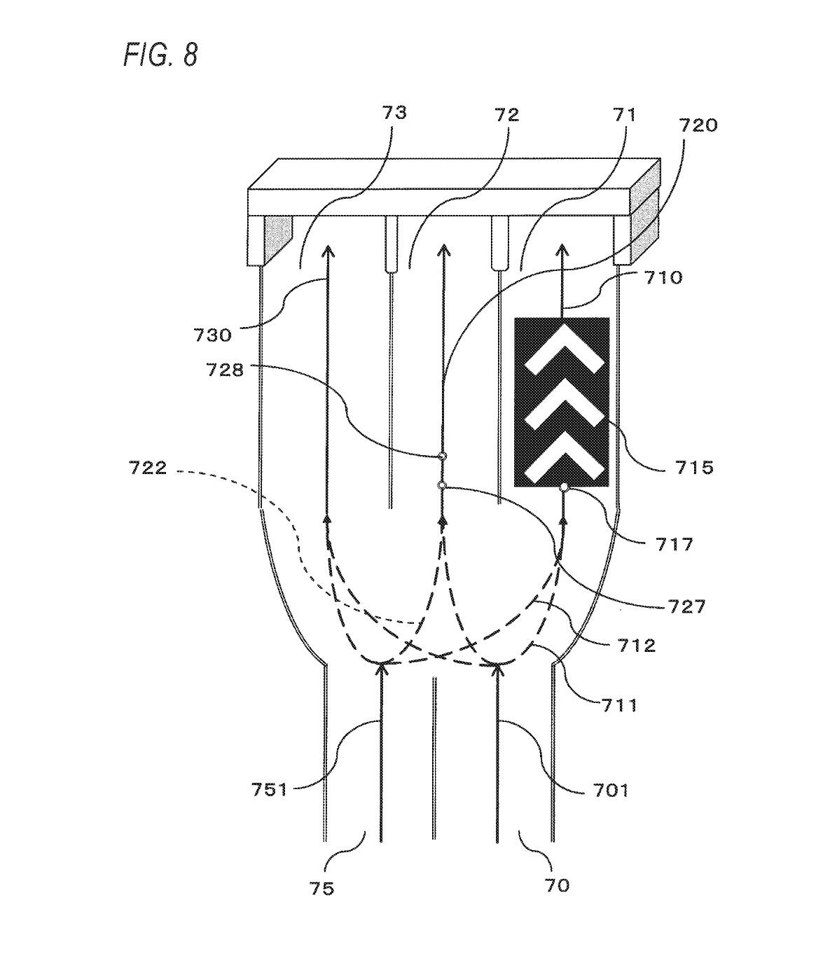

FIG. 8 is a view illustrating the lane base line and the lane base line associated line. In FIG. 8, a lane paint 715 formed in a chevron pattern is present as a feature that represents a travel mode of each lane. Such a lane paint 715 is to mark a shape including the chevron pattern with pavement of a predetermined color on a road surface in order to indicate that a specific lane is an ETC dedicated lane at an expressway tollgate.

In FIG. 8, the predetermined color used at the lane paint 715 is represented in black color as being all one color. The lane paint 715 is a feature that gives information about the traveling environment of the traveling lane of the vehicle to road movers through a difference in a color hue of the road surface. That is, the lane paint 715 is painted with a color different from a pavement color of a front road portion in the vehicle traveling direction. For this reason, when an image pickup camera (a CCD camera) is adopted as a form of the vehicle state acquisition unit 230 constituting the driving support system 10, a difference in color hue between the pavement color of the traveling road portion of the vehicle and the predetermined color of the lane paint 715 can be detected by the CCD camera. This can be used in a self-position estimating process of the vehicle by indicating that an own vehicle is present on a specific lane on which the lane paint 715 is present.

In FIG. 8, a point 717 located in front of the lane paint 715 in the vehicle traveling direction is a point indicating that, in a relationship with the traveling lane of the vehicle which is represented by the lane base line (in which the lane base line associated line treated as the same information as the lane base line is included, which will be described in the following paragraphs) in the present embodiment, the vehicle enters an existence region of the lane paint 715 on the road surface. With respect to this, in terms of a data content stored in the memory unit 43, shape data corresponding to the existence region of the lane paint 715 on the road surface is stored in the memory unit 43 as the feature shape information 435, and the point 717 is included in the feature shape information 435 as one coordinate point for describing the existence region of the lane paint 715 as a polygonal shape. The point 717 is stored as a content indicating that it is a foremost coordinate point in the vehicle traveling direction among coordinate points at which a linear shape stored as lane base line information 710 and the existence region of the lane paint 715 overlap each other in the feature disposition information 433 performing correlation between the lane information 431 including the lane base line information 710 and the feature shape information 435. In this way, in the present embodiment, the driving support system 10 performs a readout process from the feature disposition information 433 at a point that begins to pass through the lane paint 715, and is provided with a mechanism that allows the vehicle management unit 200 to use a content of a captured image of the CCD camera constituting the vehicle state acquisition unit 230 to estimate a position of the own vehicle.

Next, the lane base line associated line is treated as the same information as the lane base line after step S320 of FIG. 9 by the driving support system 10 of the present embodiment, which will be described using FIG. 8. Since processes of steps S310 and S330 are identical to those of steps S110 and S130 of FIG. 3, description thereof will be omitted.

In the road environment as illustrated in FIG. 8, the vehicle 20 may enter the ETC dedicated lane after a steering operation is performed to a right side from a lane 75. In this case, if estimation of own vehicle position according to a GPS positioning method is not performed with accuracy, the driving support system 10 is configured to detect that a course is taken from the lane 75 to the ETC dedicated lane 71 by combining information obtained from an autonomous navigation sensor as well. Meanwhile, in the case as illustrated in FIG. 8, the lane 75 and the ETC dedicated lane 71 are not connected each other in a straight direction of the lane 75. For this reason, as an exemplary type of the travel track which the vehicle 20 performing a change in the course from the lane 75 to the ETC dedicated lane 71 should take, information of a linear shape making up for lane base line information 751 corresponding to the lane 75 and lane base line information 710 corresponding to the ETC dedicated lane 71 is required. This is information representing the aforementioned lane base line associated line. And, an information content of the lane base line associated line 712 as making up for the lane base line information 751 and the lane base line information 710 is illustrated in FIG. 8.

Meanwhile, even if the driving support system 10 uses the information obtained by the autonomous navigation sensor in combination with the GPS positioning method, a pattern of the travel track drawn by the vehicle that travels by performing an steering operation to a right side from the lane 75 is roughly divided into a pattern in which the vehicle travels by performing a great steering operation to the right side as indicated by the lane base line associated line 712 of FIG. 8, and a pattern in which the vehicle travels by performing a relatively small steering operation to the right side as indicated by a lane base line associated line 722. However, since both are the same travel mode in that the vehicle travels by performing the steering operation to the right side, when there is erroneous detection of the autonomous navigation sensor in relation to whether the relatively great steering operation or the relatively small steering operation is performed from the viewpoint of the own vehicle position estimation, a process of correcting information associated with the erroneous detection using another piece of information obtained by the vehicle state acquisition unit 230 is preferably performed.

Here, the process of correcting the own vehicle position in a relationship with the processing content of the vehicle management unit 200 at each step in the processing flow illustrated in FIG. 9 will be described. To be specific, the process of correcting the own vehicle position by the vehicle management unit 200 in a scene in which the vehicle 20 travels by changing the course from the lane 75 to the ETC dedicated lane 71 under the road environment illustrated in FIG. 8 will be described.

The vehicle management unit 200 treats lane base line associated line information as the same information as the lane base line information, and specifies whether a position of the own vehicle is present at any of forked routes connected to lanes (three lanes of the ETC dedicated lane 71 and lanes 72 and 73 of general lanes in FIG. 8) of the expressway tollgate from the lane 75 (step S320). To be specific, the vehicle management unit 200 specifies vehicle trajectory that the vehicle 20 enters a course from the lane 75 through which the vehicle 20 goes straightly to pass until then to the lane of the expressway tollgate via a point at which the steering operation in a rightward direction is preferably initiated by adding the information obtained by the autonomous navigation sensor based on present position information that is obtained by the GPS positioning method—the method cannot bring an accurate estimation in this case as described above. Here, although the actual vehicle 20 is located at a curve portion indicated as the lane base line associated line information 712 in FIG. 8, a position of the vehicle specified by the vehicle management unit 200 in step S320 is set to be a predetermined point of the curve portion indicated by the lane base line associated line information 722. This is caused, as described above, by the erroneous detection of the autonomous navigation sensor with respect to the result of the steering operation in the rightward direction (with respect to whether the relatively great steering operation or the relatively small steering operation is performed in the rightward direction).

As described above, the lane paint 715 is to indicate that, for a person passing the lane thereof, the lane is the ETC dedicated lane by painting the lane in a color different from that of the typical pavement of the road surface. Then, the difference in color hue between the color of the typical pavement of the road surface and the color of the lane paint 715 is detected by the information of the vehicle state acquisition unit 230. In this case, it turns out, definitely, that the vehicle equipped with the vehicle state acquisition unit 230 is not present on the other general lanes at an expressway tollgate but on the ETC dedicated lane.

In this way, based on the lane base line associated line information included in the lane information 431 corresponding to the specified traveling lane of the own vehicle, when the vehicle is allegedly estimated to pass the represented lane 72 (one of the general lanes illustrated in FIG. 8) of the lane base line information 720 which is directly connected to the lane base line associated line 722, the driving support system 10 according to the present embodiment dismisses the information representing the traveling lane specified in step S320 above as being an error when the difference in color hue caused by the paint on the road surface is detected (NO of step S340), returns to step S320, reads out the lane base line information included in the lane information 431 to which the information associated with the existence region of the feature generating the difference in color hue from the typical road surface due to the paint on the road surface detected actually corresponds via the feature disposition information 433, and specifies the traveling lane corresponding to the actual own vehicle position again, thereby performing the process of correcting the traveling lane.

When the vehicle 20 changes the course from the lane 75 to the general lane 72 and travels along the course, but the traveling lane of the own vehicle is misspecified to be the course directed to the ETC dedicated lane 71, the process of correcting the traveling lane is as follows. Assuming that the lane base line associated line information (712 of FIG. 8) included in the lane information 431 corresponding to the misspecified traveling lane is provided, the vehicle state acquisition unit 230 mounted in the vehicle 20 is to detect the difference in color hue caused by the paint on the road surface at a position equivalent to the point 717 at which passage is scheduled. On the contrary, although it is supposed by autonomous navigation that the vehicle 20 goes through the lane base line associated line 712 to reach the point 717 on the lane base line 710 (in FIG. 8, although the vehicle management unit 200 supposes that the vehicle 20 reaches the point 717 on the lane 71 based on the autonomous navigation in light of an amount of movement on the misspecified traveling lane at the point in time when the vehicle 20 reaches a point 728 overrunning a point 727 that is horizontally the same position as the point 717), the vehicle state acquisition unit 230 does not actually detect the difference in color hue of the paint on the road surface. This is because the vehicle 20 actually takes a track on which it goes through the lane base line associated line 722 to travel on the lane 72, namely the general lane, represented by the lane base line 720. Thereby, as the pre-specified traveling lane of the vehicle 20 turns out to be incorrect, the vehicle management unit 200 returns to the process of specifying the present position of the vehicle, and performs the process again. The reason is that, as a result of accumulating the amount of movement of the vehicle 20 according to the autonomous navigation premised on a result of specifying the precedent traveling lane, although the vehicle management unit 200 supposes that the vehicle 20 reaches the point 717 on the ETC dedicated lane, the difference in color hue of the paint on the road surface is not detected, which has an opportunity to determine that a premise itself that the vehicle 20 is located in a travel lane passing through the ETC dedicated lane on which the lane paint 715 is laid is wrong. Accordingly, even in this case, the driving support system 10 dismisses the information representing the traveling lane specified in step S320 above as being an error (NO of step S340), and the vehicle management unit 200 returns to step S320, and specifies the traveling lane corresponding to the actual own vehicle position again, thereby performing the process of correcting the traveling lane.

Of course, in step S320 above, from the GPS positioning method and the detected result of the autonomous navigation sensor, the position at which the vehicle 20 is present is set as the position corresponding to the lane base line associated line 712, and the traveling lane is specified to be matched with the existence position of the actual vehicle. In this case, the color of the lane paint having the color hue different from that of the typical road surface is acquired at the point 717 of FIG. 8 by the vehicle state acquisition unit 230, and this is an event, occurrence of which is naturally scheduled at the time of the passage of the lane specified in this way (since the information of the point 717 is included in the feature disposition information 433), and therefore, the driving support system 10 does not dismiss the specified result of step S320 in which the traveling lane of the vehicle 20 is specified (YES of step S340), and the vehicle management unit 200 maintains the specified result of the traveling lane of the vehicle 20, and performs a process of outputting predetermined information required for the braking control, supplying the information to the vehicle controller 250, for example, to reliably carry out toll settlement at ETC based on the specified result (step S350).

### D. Modification

This disclosure is not limited to the aforementioned embodiments, and can be carried out in various modes without departing from the spirit and scope of the disclosure. For example, the following modifications are possible.

### D1. First Modification

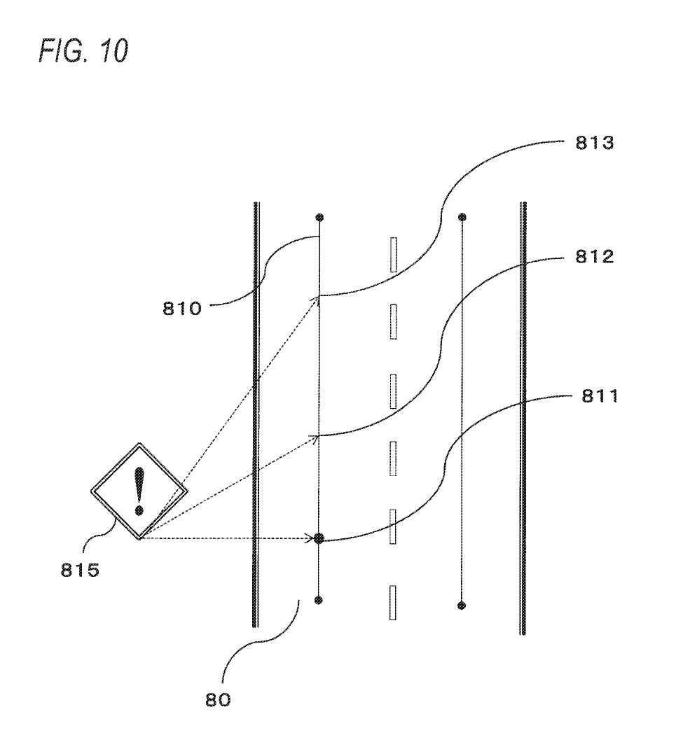

FIG. 10 illustrates an example in which the lane base line information corresponding to the lane with respect to the one-side 2-lane road is stored as the lane information 431, the content of the traveling environment represented by the feature and the existence position of the feature are stored as the feature shape information 435 with respect to the feature indicating the traveling environment in the lane, and in which range the traveling environment represented by the feature is available on the lane is recorded as the feature disposition information 433.

In the traveling environment illustrated in FIG. 10, a feature 815 is a warning sign having a sign name called “other dangers.” This is a sign indicating that there is a situation for which a driver should watch out in front of a traveling road. The road situation to watch out, which is indicated by the warning sign of the feature 815 may include various situations. To name a few, a vehicle traveling along a road shoulder-side lane due to a weak road shoulder should watch out for the road shoulder, or, a vehicle should avoid traveling excessively leaning to the road shoulder so as not to be in danger of tumbling from a coastal road. However, this feature 815 is different from the feature 515 described in the first embodiment in the following points. The feature 515 in the first embodiment is the lane paint. An intersection between a lane paint and a lane base line represented by an approximate center line is set by two coordinates of a foremost point in a vehicle traveling direction and a rearmost point in the vehicle traveling direction and is stored in the memory unit 43. Thereby, length information that is available in the traveling environment represented by the feature (in the case of the feature 515, an environment in which stop control of the vehicle is prohibited within a range in which the lane paint of a stop prohibition portion is present) can be thoroughly expressed in a relationship with the lane. However, in the case of the feature such as the feature 815 in FIG. 10, in which length range the traveling environment represented by the feature is available for the lane is not clear from information of a position at which the feature is installed, particularly, with respect to the vanishing point of the traveling environment represented by the feature.

In the example illustrated in FIG. 10, when a perpendicular is drawn down from a position at which the feature 815 is present to a lane base line 810, a road mover can recognize that the traveling environment to give warning, called “other dangers.” is present at least on a point of an intersection 811 between the lane base line 810 and the perpendicular. However, since the warning sign such as the feature 815 is different, in an installation form of a sign, from a regulation sign in which length information of a regulation section is clearly defined by existence positions themselves of auxiliary signs corresponding to a start and an end of the regulation section, a driver cannot identify from the information of the existence position of the feature 815 at which point the traveling environment called “other dangers” comes to an end. As for the example illustrated in FIG. 10, whether a driver has only to travel to a point 812 or a point 813 along with a lookout is not ascertained only by detecting the existence position of the feature 815 by means of information of the vehicle state acquisition unit 230. Therefore, to modify and use the data structure shown in the first embodiment of the present disclosure, namely the data structure in which the specific control starting point SP and the specific control endpoint EP on the lane base line in the feature disposition information 433 are stored is suitable in the traveling environment as illustrated in FIG. 10.

To be specific, with respect to the traveling environment represented by the feature 815 called “other dangers,” the starting point SP and the endpoint EP of the traveling environment represented as the “other dangers” in a relationship with the lane 80 may be set in the feature disposition information 433 as follows. When the perpendicular is drawn down from one of coordinate points, which are stored in the feature shape information 435 as the position where the feature 815 is present, to the starting point SP of the traveling environment in which the driver should travel along with the lookout—the starting point SP is also constituent of coordinate points representing the lane base line 810, the point of the intersection 811 between the lane base line 810 and the perpendicular is stored in the feature disposition information 433.

The endpoint EP of the traveling environment represented as the “other dangers” in FIG. 10 is information that is identified by a road manager who is obliged to investigate dangerous places around the road so as not to cause defects of installation or management of a structure around the road and is obtained by records of endpoints of dangerous places on a road side in a vehicle traveling direction. When a perpendicular is drawn down from the endpoint of the dangerous places on the road side to the lane base line 810, coordinates of an intersection between the lane base line 810 and the perpendicular are stored in the feature disposition information 433. In this way, when length information in which a specific traveling environment represented by the feature continues in the vehicle traveling direction is not ascertained only by the information of the coordinate point representing the existence position of the feature, the vehicle management unit 200 can generate information required for driving support corresponding to the specific traveling environment in a necessary range, and supply this information to the vehicle controller 250 by setting an endpoint of the traveling environment in the feature disposition information 433 in advance.

### D2. Second Modification

The configuration of the driving support system 10 of each embodiment is merely one example, and can be variously modified. For example, the information acquired by the vehicle state acquisition unit 230 is obtained by the image pickup camera (the CCD camera). However, without being limited thereto, the vehicle state acquisition unit 230 may be configured to acquire information that is received as a reflective wave from an object by a laser radar or a millimeter-wave radar.

In the related art (JP-B-4886597), after a plurality of pieces of information of features associated with road network data used for path search are set to targets to be processed for driving support, an own vehicle travel lane is discriminated. That is, in the related art, map data in which road network data represented simply as one link and the information of the features are correlated regardless of one-way multiple lanes or one-side one lane is used. When the road network data of this structure is used as information for estimating a lane in which an own vehicle is present in a driving support device, a data structure in which a specific lane and a specific feature are to correspond one to one is not formed. Even when there are features that are regulated in this conventional map data structure and represent characteristics of different traveling environments for each of the respective lanes in a one-way multi-lane road in the related art, the driving support device is configured to read out all pieces of information of the features strung to one link constituting a road network from a memory unit and to be used for a process such as own vehicle position estimation. In other words, in the driving support device of the related art, as map data of the data structure in which the link and the feature are correlated is adopted, even the information of the feature irrelevant to the lane along which the own vehicle travels is a target to be processed by the driving support device.

In each embodiment described above, the information in which lane network information in which interconnection of the plurality of lanes is represented as a network is correlated with the individual feature realizing the traveling environment of the vehicle with respect to the specific lane constituting the lane network information is held.

### D3. Third Modification

In the above embodiment, the driving support system 10 is configured to have the vehicle 20 and the server 40, each of which communicates with the other. The disclosure is, however, not limited to this configuration. The driving support system 10 may be configured such that the all the information, namely, lane information 431, feature disposition information 433 and feature shape information 435 is included in the vehicle 20 and is processed by the vehicle management unit 200.

1. A driving support apparatus comprising:
processing circuitry configured to
receive lane information and feature information of a feature situated on a road or around the road, the lane information including lane base line information of a base line arranged for each of a plurality of lanes of the road, the feature information including position information of the feature, the feature information being correlated with the lane base line information;
identify a traveling lane along which a vehicle is travelling among the plurality of lanes based on a present position of the vehicle and the lane base line information;
identify the feature information associated with the identified traveling lane; and
output information for supporting driving of the vehicle based on the feature information associated with the traveling lane.

2. The driving support apparatus according to claim 1, further comprising:
a GPS sensor configured to detect the present position of the vehicle.

3. The driving support apparatus according to claim 1, wherein the feature information further includes range information regarding to what extent a traffic situation represented by the existence of the feature stretches.

4. The driving support apparatus according to claim 1, wherein
the feature information further includes length information of a length which range covers the vehicle traveling environment corresponding to the feature in a direction of a lane base line, and
the processing circuitry is configured to output at least one piece of the information for supporting driving of the vehicle for supporting speed control of the vehicle based on the length information, or another piece of the information for supporting driving of the vehicle for supporting steering control of the vehicle based on the length information.

5. The driving support apparatus according to claim 1,
wherein processing circuitry is configured to correct the present position of the vehicle detected by a position detector based on the feature information.

6. The driving support apparatus according to claim 1, wherein the feature is a road marking situated on a surface of the road.

7. The driving support apparatus according to claim 1, wherein the feature has an effect on a travel of the vehicle.

8. The driving support apparatus according to claim 1, wherein the feature information includes a unique ID of the lane base line information and a unique ID of the feature.

9. The driving support apparatus according to claim 1, further comprising:
a camera to detect a pavement color of the road, and
the processing circuitry is configured to identify the traveling lane based on the detected pavement color.

10. The driving support apparatus according to claim 1, wherein
the processing circuitry is configured to use information of the traveling lane identified based on the detected pavement color in case the traveling lane identified based on the present position of the vehicle and the lane base line information contradicts with the traveling lane identified based on the detected pavement color.

11. The driving support apparatus according to claim 1, wherein
the processing circuitry is configured to receive the lane information and the feature information from a server.

12. A driving support server comprising:
a memory that stores lane information and feature information of a feature situated on a road or around the road, the lane information including lane base line information of a base line arranged for each of a plurality of lanes of the road, the feature information including position information of the feature, the feature information being correlated with the lane base line information; and
processing circuitry configured to transmit the lane information and the feature information to a vehicle on the road for driving support of the vehicle such that the vehicle can identify the feature information associated with traveling lane along which the vehicle is travelling among the plurality of lanes and output information for supporting driving of the vehicle based on the feature information associated with the traveling lane.

13. The driving support server according to claim 12, wherein the feature information further includes range information regarding to what extent a traffic situation represented by the existence of the feature stretches.

14. The driving support server according to claim 12, wherein the feature is a road marking situated on a surface of the road.

15. The driving support server according to claim 12, wherein the feature has an effect on a travel of the vehicle.

16. The driving support server according to claim 12, wherein the feature information includes a unique ID of the lane base line information and a unique ID of the feature.

17. The driving support server according to claim 12, wherein the feature information indicates a stop prohibition area of the vehicle.

18. The driving support server according to claim 12, wherein the feature information indicates a route fork area.

19. A non-transitory computer-readable medium having encoded thereon a data structure of road network data used for driving support of a vehicle, the data structure comprising:
lane information including lane base line information of a base line arranged for each of a plurality of lanes of a road; and
feature information of a feature situated on the road or around the road, the feature information including position information of the feature and range information regarding to what extent a traffic situation represented by the existence of the feature stretches, the feature information being correlated with the lane base line information.
